(19) United States
(12) Patent Application Publication
(10) Pub. No.: US 2008/0159195 A1
(43) Pub. Date: Jul. 3, 2008

(54) Integration of wired and wireless network connections

(76) Inventors: Elizabeth M. Kappler, Hillsboro, OR (US); Patrick Connor, Portland, OR (US); Matt Jared, Hillsboro, OR (US); Scott P. Dubal, Hillsboro, OR (US); Duke Hong, Hillsboro, OR (US)

Correspondence Address: LEE & HAYES, PLLC;c/o Intellevate, LLC, P.O. BOX 52050, MINNEAPOLIS, MN, 55402, US

(21) Appl. No.: 11/648,446

(22) Filed: Dec. 29, 2006

(51) Int. Cl. G08C 17/02

(52) U.S. Cl. 370/311

(57) ABSTRACT

Embodiments of an integrated device comprising portions of wired and wireless network communication devices are presented herein.

### BACKGROUND

Computing devices, such as personal computers (PCs) are often connected to other computing or peripheral devices through communication networks. Wired and wireless communication devices are utilized to send and receive data to and from the networks and to provide an interface with the computer. Currently, separate semiconductor chips are used for each wired and wireless device. Moreover, the wireless communication device conventionally resides on a separate networking semiconductor chip from the processor. This separation of the devices may be expensive because of costs of production and assembly, the cost of increased power consumption to power multiple separate chips, and so on.

### BRIEF DESCRIPTION OF THE DRAWINGS

FIG. 1 is a block diagram illustrating a conventional computing system comprising separate wired and wireless communication devices;

FIG. 2 is a block diagram illustrating an integration of wired and wireless communication device components in an input/output controller or networking semiconductor chip;

FIG. 3 is a block diagram illustrating an integration of wired and wireless communication device components in an input/output controller or networking semiconductor chip in which the wired and wireless network connection devices share a component, such as a shared packet interface, a host interface and/or a manageability engine;

FIG. 4 is a block diagram illustrating an integration of wired and wireless communication device components in an input/output controller or networking semiconductor chip in which the wired and wireless network connection devices share a component, such as a shared packet interface, a host interface and/or a manageability engine and in which the wireless PHY resides on a separate semiconductor chip; and

FIG. 5 is a flow chart showing a method of enabling a network connection device in first and second power modes.

### DETAILED DESCRIPTION

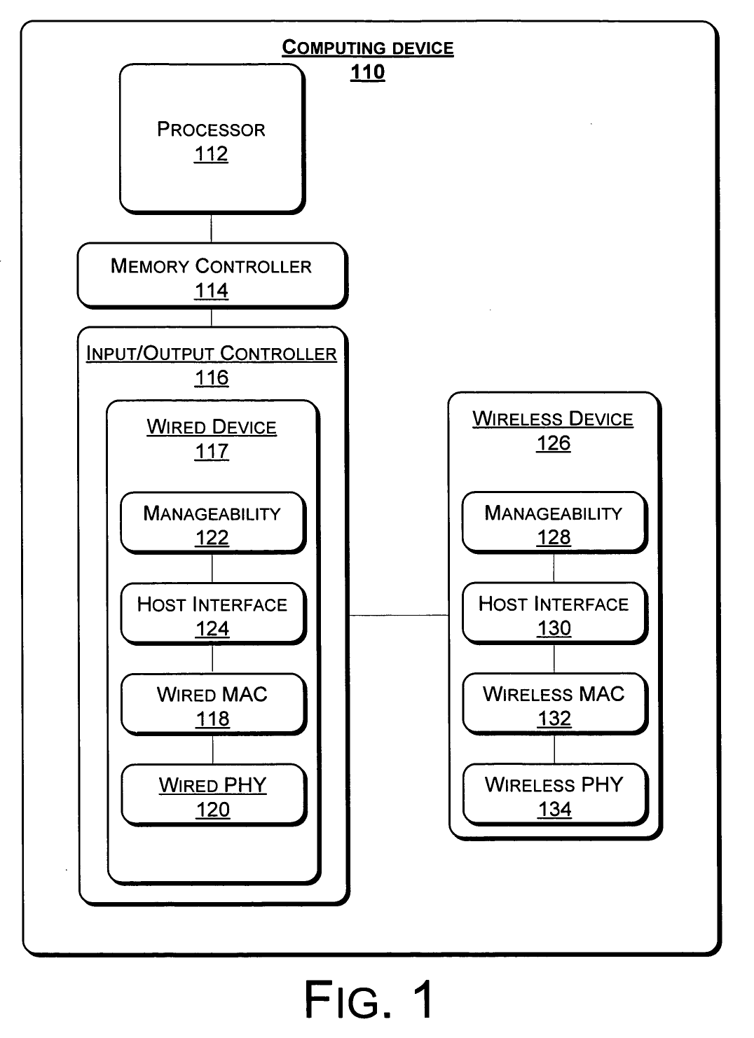

FIG. 1 illustrates a computing device 110, such as a personal computer, which may have a processor 112. Processor 112 may be connected to a memory controller 114 and an input/output controller 116. Memory controller 114 may be a memory controller hub (MCH) and the input/output controller 116 may be an input/output controller hub (ICH). The memory controller and/or input/output controller may alternatively be on or in the same chip as the processor. The input/output controller 116 may be a multifunctional controller apparatus that provides an interface to systems such as the PCI bus and the memory controller 114. It may communicate with the memory controller over a dedicated hub interface.

Input/output controller 116 may have an integrated wired communication device 117 for connecting the computing device 110 to a wired network, such as a local area network (LAN), wide area network (WAN) and/or the Internet. Wired communication device 117 may have a manageability engine or block 122 and/or host interface 124. Host interface 124 may connect the device with the operating system (OS). The manageability engine 122 may allow management of low power states and remote access functions such as power up, wake up, diagnostics and/or system maintenance. For example, manageability engine 122 may receive wake up packets or diagnosis packets as part of a remote maintenance diagnosis. To permit and/or perform this operation, manageability engine 122 may be operational when the rest of the network chip and/or processor is disabled.

The wired communication device may alternatively be incorporated at least in part with a semiconductor chip that is separate from the processor. This chip may be referred to as a networking apparatus or “networking silicon.” The chip may be connected to the processor through one or more interconnections, such as a PCI slot.

Input/output controller 116 may also be connected to a wireless communication device 126 for connecting the computing device 110 to a wireless network. Wireless communication device 126 has its own associated manageability engine 128 and/or host interface 130, which may perform similar functions as manageability engine 122 and host interface 124, respectively, but tailored for the wireless communication device 126.

As shown in FIG. 1 and described herein, wired and wireless network connection devices each may have physical (PHY) and medium-access-control (MAC) network layers. For example, wired communication device 117 may include a wired MAC 118 and wired PHY 120. Wireless communication device 126 may comprise a wireless MAC 132 and wireless PHY 134. The wired PHY 120 may be a wire or cable, such as a Category 5 (Cat 5) cable or other conventional networking cable. The wireless PHY 134 may include one or more antennas, such as a dipole antenna.

### Integrated Device with Wireless and Wired Network Connection Devices

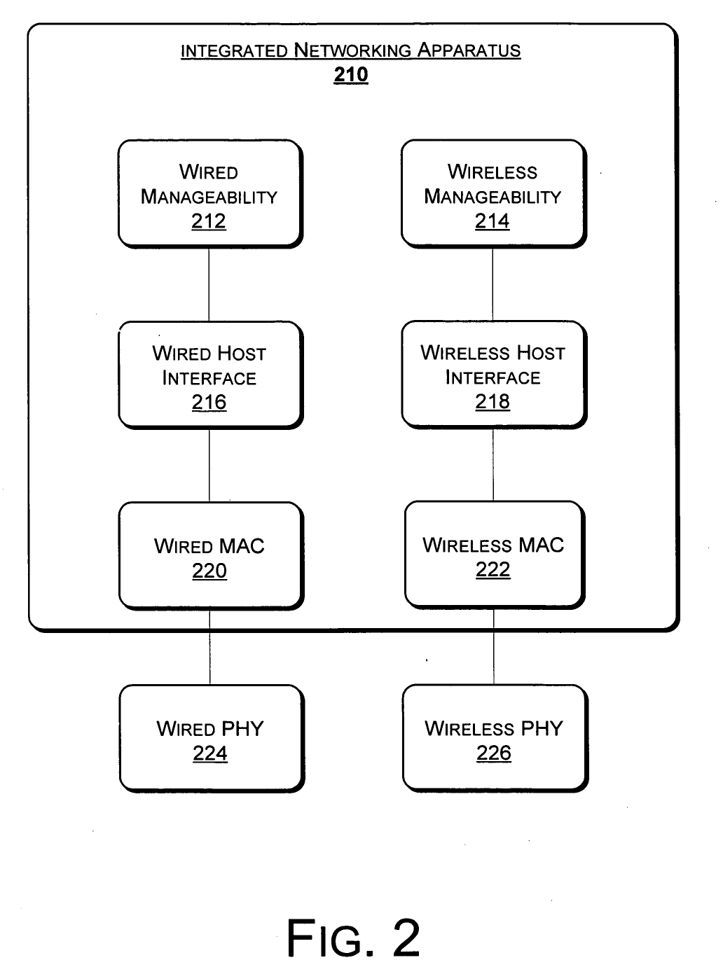

Components of the wired and wireless communication devices may be combined onto the same integrated circuit to form an integrated networking apparatus 210, an example of which is shown in FIG. 2. The integrated networking apparatus 210, for instance, may be part of an input/output controller block on a motherboard of the computing device 100 of FIG. 1, may be incorporated on a discrete networking semiconductor device (e.g., as an integrated circuit and/or a networking silicon chip), and so on. If the networking apparatus 210 is formed as a discrete semiconductor device apart from the processor and chipset (e.g. networking silicon), it may be connected to components on the motherboard using a variety of connection techniques, such as direct connection (e.g., soldering, conductive paste), indirect connection (e.g., through a peripheral component interconnect interface), and so on. For example, the networking apparatus 210 may be incorporated on a network interface card (NIC) that can be connected to a processor, such as the processor 112 of FIG. 1.

As shown in the example of FIG. 2, the wired and wireless communication devices may have their own associated manageability engines 212 and 214 and/or host interfaces 216 and 218, respectively. Additionally, the MAC layers 220 and 222 may be formed on and/or within the same integrated networking device 210. It should be noted that in the example of FIG. 2, however, the wired PHY 224 and wireless PHY 226 may be formed separately. For instance, each PHY may be on or within an integrated circuit that is connected to the networking apparatus 210. Alternatively, the wired PHY 224 and/or wireless PHY 226 may be formed as functional blocks on the networking apparatus 210.

According to the implementations shown in FIGS. 1 and 2, several advantages can be obtained. For example, cost of production can be decreased by incorporating portions of the wired and/or wireless communication devices on the networking apparatus. Furthermore, power consumption may be reduced and other advantages may be obtained.

### Shared Packet Interface

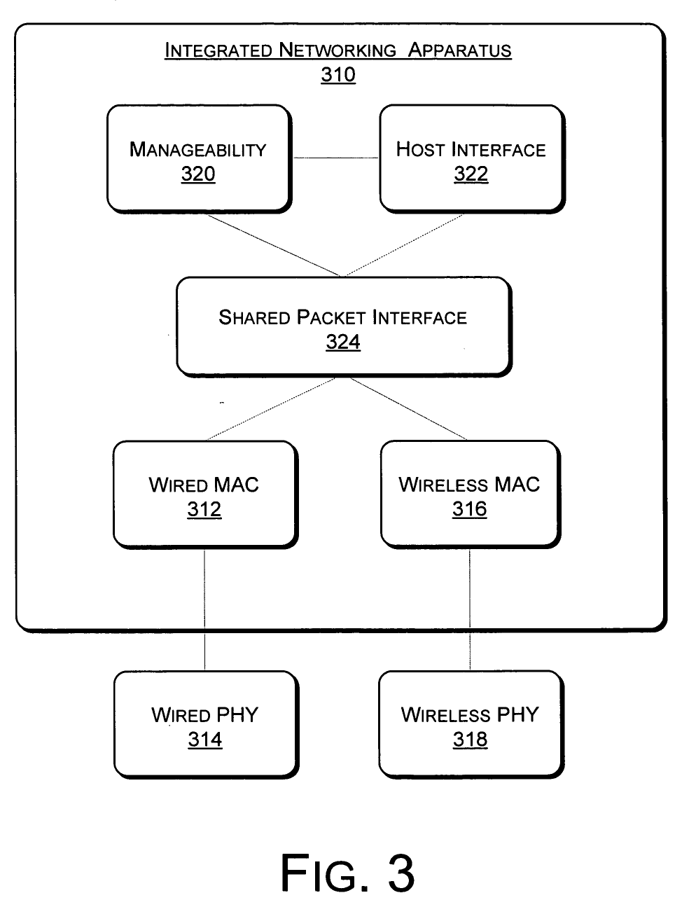

The systems shown in FIGS. 1 and 2 have separate manageability engines and host interfaces for the wired MAC and wireless MAC. As shown in FIG. 3, an integrated networking device 310 may incorporate at least a portion of a wired network connection device, which may include wired MAC 312 and wired PHY 314, and wireless network connection device, which may include a wireless MAC 316 and wireless PHY 318. The wired connection device and wireless connection devices may share a manageability engine 320 and/or a host interface 322, which may be addressed through a shared packet interface 324. These shared functions may be provided as blocks on the integrated networking apparatus 310, which, as mentioned previously, may be an input/output controller or networking silicon.

The shared packet interface 324 may include a packet buffer and packet filters. Packets entering from an external interface, such as the wired MAC 312 or wireless MAC 316 may be filtered and sorted by the packet filter and then stored in the packet buffer memory and placed in different queues for delivery to an application module that is executable on a processor, such as the processor 112 of FIG. 1. One such application module may be the operating system (OS). Once the packet is received by the shared packet interface 324, the header may be removed, an interrupt may be sent to the operating system, and the packet may delivered to the host so that the OS may process it. Packets entering from an internal interface, such as a host interface 322 or manageability engine 320, for example, may be moved directly to the shared packet interface 324. These packets may be marked to be sent by either the wired MAC 312 or wireless MAC 316. A header may be utilized to determine which communication device is to receive the data. Thus, rather than use separate blocks for the manageability engine 320 and host interface 322 for the wired and wireless devices, these blocks could be shared through the shared packet interface 324.

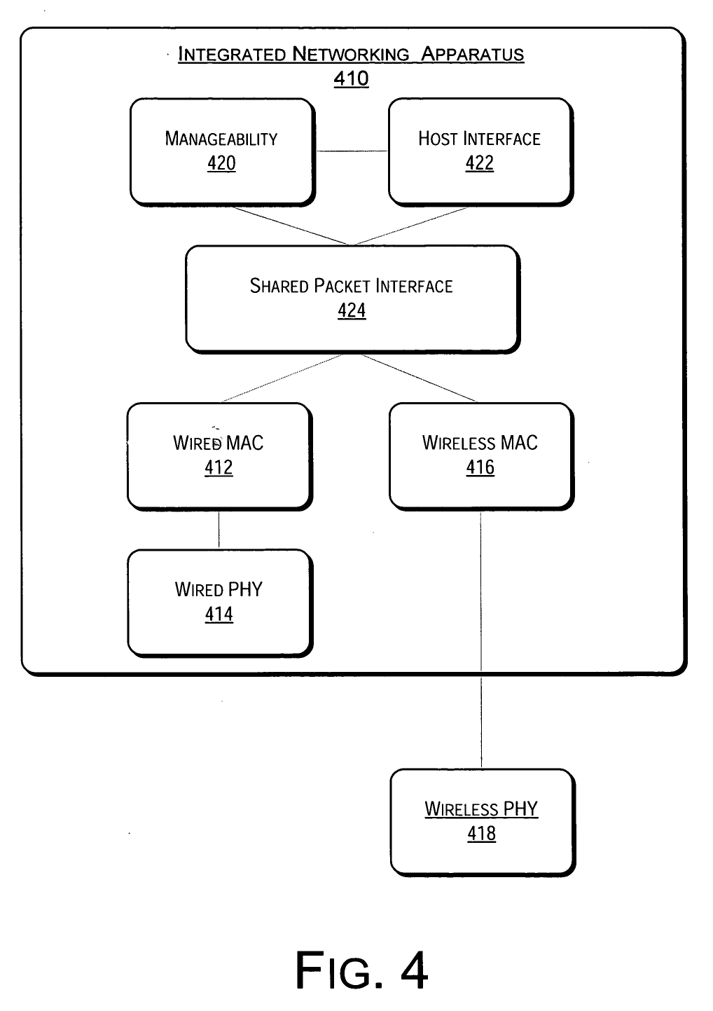

As described above, the integrated networking device 310 could have the wired MAC 312 and wireless MAC 316 on the same semiconductor chip. The wired PHY 314 and wireless PHY 318 may also be formed separate from each other and separate from the integrated networking apparatus 310. Alternatively, the wired PHY 314 and/or wireless PHY 318 could be provided on the same semiconductor chip as the wired MAC 314 and wireless MAC 320. For example, FIG. 4 illustrates another example in which the wired MAC 412 and wired PHY 414 are provided on the integrated networking apparatus 410. The wireless MAC 416 may also be provided on integrated networking apparatus 410, while wireless PHY 418 may be provided by a separate chip. Thus, a single chip could contain the wired networking functionality and at least a portion of the wireless functionality. Furthermore, as described above, portions of the digital logic, including a manageability engine 420, a host interface 422 and a shared packet interface 424 could be shared between the wired and wireless devices.

According to the implementations shown in FIGS. 3 and 4, several advantages can be obtained. Cost and power can be reduced by having portions of the silicon shared between the wired and wireless connection devices. Additionally, when logic is shared between the wired and wireless connection devices, the overall gate count may be reduced, which may reduce fabrication costs, increase system performance and/or increase the number of functions that may be performed by the integrated device 310.

### Wireless Access Point

The wired and wireless communication devices described above may operate as a wireless access point (WAP). The WAP may send packets directly between the wired and wireless devices via the shared logic, such as the shared packet interface. The WAP can be operated in normal operating power, such as when the host, e.g., a personal computer (PC) or other computing device, is placed in its “on” state, or in a reduced power mode, such as when the host is shut down, hibernated, or placed in any other state of reduced power or functionality. In a personal computer (PC) environment, for example, this allows a WAP to be created through the PC itself. A logic block in the shared packet interface may determine which packets are destined for the host interface and which are to be passed between the wired and wireless connections and may act as the switch between the wireless MAC and wired MAC. This shared packet interface would also allow packets to be sent directly between the wireless MAC 312 and the wired MAC 316 interfaces.

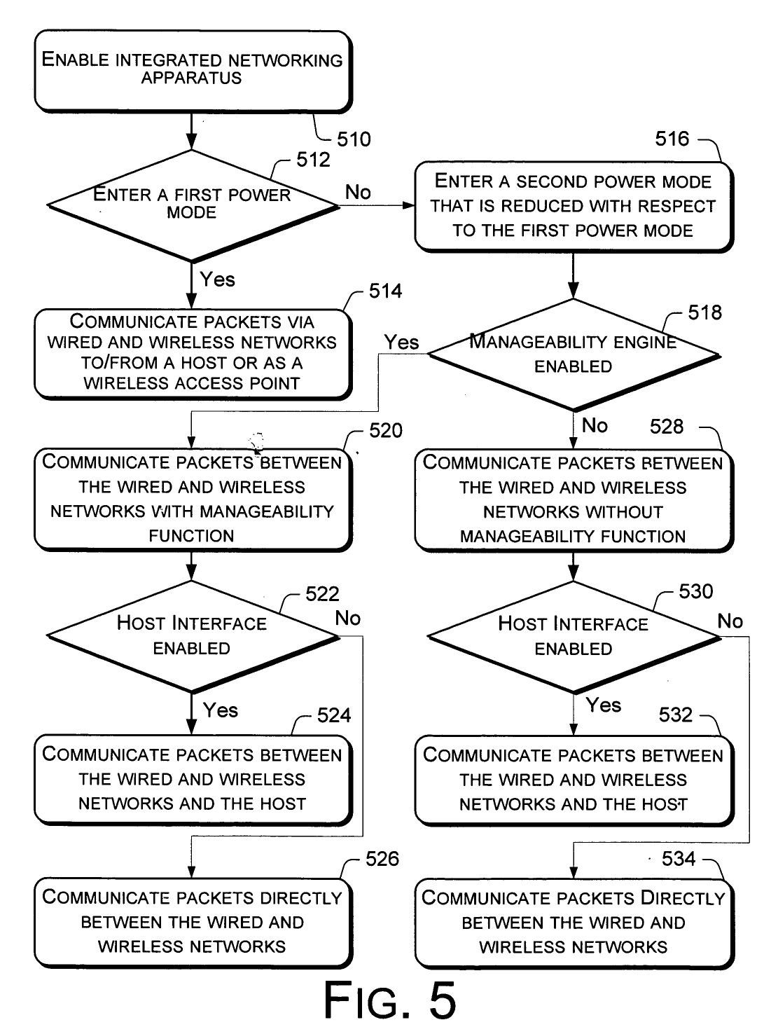

As shown in the flow chart illustrated in FIG. 5, the integrated network connection apparatus may be enabled in a first power mode such that the network connection device is operable to communicate packets from a host interface via wired or wireless networks as shown in blocks 510, 512 and 514. In the first power mode, the integrated network connection apparatus could have full functionality including a manageability engine, host interface, and any functionality from portions of the wired and wireless MAC that were disabled in the low power mode but that are enabled in the full power mode. An example of this power mode is when the computing device is activated, or in an “on” state, such as when a user boots up a PC.

The integrated network connection device could enter a second power mode, shown in block 516, which is reduced with respect to the first power mode. In the reduced power mode, the network connection device is still operable to communicate packets between the wired and wireless networks. However, certain portions of the wired and wireless devices may be disabled to reduce power demands. Alternatively or additionally, the manageability engine and/or host interface may be disabled. As shown in blocks 518 and 520, if the manageability engine is enabled, the system can communicate packets of information between the wired and wireless networking device and may allow for manageability functions, such as remote access and remote maintenance. The host interface may be disabled or enabled as shown in blocks 522, 524 and 526. Enabling the host interface during the reduced power mode, and when the manageability engine is enabled, may allow the networking apparatus to communicate with the host and have a manageability function, while disabling the host interface would conserve power.

As shown in block 528, if the manageability engine is disabled, the system may communicate packets of information between the wired and wireless networking device, though manageability functions may not be available. Disabling the manageability engine would reduce the logic activated in the reduced power mode, thus conserving power. Moreover, the host interface may be disabled or enabled as shown in blocks 530, 532 and 534. Enabling the host interface may allow the networking apparatus to communicate with the host. Disabling the host interface would conserve additional power. With host interface and manageability functions disabled, packets would be passed directly between the wired and wireless communication devices.

The method set forth above and represented in FIG. 5 can be illustrated by way of example. When the network connection device is entered into the first power mode, the manageability engine, shown for example in FIG. 3, may perform a manageability function. Placing the integrated networking device into the second and reduced power mode may disable the manageability engine. This would allow communication between the host, the wired device, and the wireless device, but would not allow for manageability functions, such as remote access or maintenance. However, in an implementation, logic may be included in the manageability engine to allow manageability functions to operate when the computer was “off”. Additionally or alternatively, the host interface may be disabled in the reduced power mode. In such an instance, the wired and wireless devices would allow packets to be sent between the wired and wireless networks without signification interaction with the host.

The amount of power consumed for operation of the device in the first and second power modes may depend on what blocks are activated and in use. For example, in a typical normal or high power mode, logic blocks are utilized for advanced features to increase throughput rate, improve efficiency, and so on. In a low power mode, these advanced feature blocks may be temporarily disabled or shut down. Additionally or alternatively, as mentioned above, the host interface and/or the shared packet interface could be disabled. Low power could also be achieved in various other ways known to those skilled in the art.

The integrated networking apparatus may additionally have an automatic wireless radio power off feature. With this implementation, the wireless connection is enabled when the computer is in reduced power mode, such as described above. When the networking apparatus is operated a power higher than the reduced power mode, the wireless connections are migrated and the wireless portions may be disabled to preserve power.

The integrated networking apparatus may receive power using Power Over Ethernet (IEEE 802.3af) technology, in accordance with, for example, the IEEE 802.3af standard, IEEE Std 802.3af-2003 published Jul. 11, 2003, to power either or both the wired and wireless network interfaces. This may be particularly useful when the device is running in a reduced power mode.

Although details of specific implementations are described above, such details are intended to satisfy statutory disclosure obligations rather than to limit the scope of the following claims. Thus, the invention as defined by the claims is not limited to the specific features described above. Rather, the invention is claimed in any of its forms or modifications that fall within the proper scope of the appended claims, appropriately interpreted in accordance with the doctrine of equivalents.

1. An apparatus comprising:
a wireless communication device to provide a wireless network connection;
a wired communication device to provide a wired network connection; and
a packet interface that is shared by the wireless and the wired communication devices.

2. An apparatus as recited in claim 1, wherein the packet interface is operable to provide a connection between the wireless and the wired communication devices with an application module that is executable on a processor.

3. An apparatus as recited in claim 2, wherein the application module is an operating system.

4. A system as recited in claim 2, wherein the packet interface and the wireless and the wired communication devices are incorporated within an input/output controller of a motherboard that includes the processor.

5. An apparatus as recited in claim 1, wherein the wireless communication device and wired communication device are provided by a single integrated circuit.

6. An apparatus as recited in claim 5, wherein the wired communication device includes a wired physical layer device (PHY) on the single integrated circuit.

7. An apparatus as recited in claim 1, wherein:
the wireless communication device comprises a wireless medium access control device; and
the wired communication device comprises a wired medium access control device.

8. An apparatus as recited in claim 1, wherein the packet interface addresses a host interface that is shared by the wireless and the wired communication devices.

9. An apparatus as recited in claim 1, wherein the packet interface addresses a manageability engine that is shared by the wireless and the wired communication components.

10. An apparatus as recited in claim 1, wherein the wireless and the wired communication devices are operable to provide a wireless access point.

11. An apparatus as recited in claim 10, wherein the wireless access point is enabled when the packet interface is in a reduced-power mode.

12. An apparatus as recited in claim 1, further comprising a host interface that is operable to communicatively couple the wireless and the wired communication devices with an operating system, wherein the wireless and the wired communication devices are operable to provide a wireless access point when the host interface is in a reduced-power mode.

13. A single integrated circuit comprising wired and wireless medium access control devices.

14. A single integrated circuit as recited in claim 13, wherein the wireless medium access control device shares at least one component of the wired medium access control device.

15. A single integrated circuit as recited in claim 14, wherein the at least one component is selected from a group consisting of: a manageability component, a host interface or a packet interface.

16. A method comprising:
entering a first power mode by a network connection device such that the network connection device is operable to communicate packets from a host interface via wired or wireless networks; and
entering a second power mode by the network connection device that is reduced with respect to the first power mode, and in which, the network connection device is operable to communicate packets between the wired and wireless networks when the host interface is disabled.

17. A method as recited in claim 15, wherein the entering of the first power mode by a network connection device enables a manageability engine to perform a manageability function.

18. An apparatus comprising:
a dipole antenna; and
an integrated circuit having a wireless communication device communicatively coupled to the dipole antenna to provide a wireless network connection and a wired communication device to provide a wired network connection, wherein the wired communication device shares at least one logic component with the wireless communication device.

19. An apparatus as recited in claim 18, wherein the at least one logic component is a manageability engine, a host interface or a shared packet interface.

20. An apparatus as recited in claim 18, wherein the apparatus has a first power mode such that the apparatus is operable to communicate packets from a host interface via wired or wireless networks; and a second power mode that is reduced with respect to the first power mode, in which, the apparatus is operable to communicate packets between the wired and wireless networks when the host interface is disabled.
